(19) United States
(12) Patent Application Publication
(10) Pub. No.: US 2011/0093382 A1
(43) Pub. Date: Apr. 21, 2011

(54) SYSTEM AND METHOD FOR FUNDING A PREPAID CARD ACCOUNT WITH A LOAN

(75) Inventors: Tim Coltrell, Danville, CA (US); Vickie Lim, Alameda, CA (US); Matt Montes, Danville, CA (US); Greg Pacheco, Walnut Creek, CA (US); Dave Petrini, Tiburon, CA (US); Simon Williams, Walnut Creek, CA (US)

(73) Assignee: AccountNow, Inc., San Ramon, CA (US)

(21) Appl. No.: 12/582,421

(22) Filed: Oct. 20, 2009

(51) Int. Cl. G06Q 40/00; G06Q 20/00

(52) U.S. Cl. 705/38; 705/41; 705/40

(57) ABSTRACT

Systems and methods for funding a prepaid card account with a loan are disclosed. One embodiment includes, receiving, by an account manager at a host server, a request from a customer to fund the prepaid card account through obtaining a loan from a lender, comparing user data of the customer to a set of metrics to determine whether the customer meets qualifications for funding the prepaid card account through the loan, comparing user data of the customer to a set of metrics to determine whether the customer meets qualifications for funding the prepaid card account through the loan, presenting the terms of the loan to the user via the user device, and/or funding, by the account manager, the prepaid card account using the loan, responsive to the customer accepting the terms of the loan.

### BACKGROUND

Generally, providers of financial solutions benefit from lead generation in developing business. This is because lead generation drives individuals to financial services providers. Wholesalers, retailers, and other commercial establishments have a steady stream of customers which may desire financial solutions. Further, many of these customers are part of the 70-80 million persons in the United States that do not have the benefit of a bank account or credit card. Often the commercial establishments are in a position to offer financial services because their customers are using websites or are physically located in stores.

Sometimes offering these financial services will help the commercial establishment to sell additional products and services. For Example, a store may require a bank account, credit, debit, or prepaid card, to purchase a service, but a customer may not have a bank account, credit, debit, or prepaid card, even though he has available funds and a steady stream of income. Such a non-banked Applicant is not served. Absent a financial service that would immediately provide the individual with an account the business may be lost.

### BRIEF DESCRIPTION OF THE DRAWINGS

FIG. 1 illustrates a block diagram of client devices and a host server capable of funding a prepaid card account for a customer with a loan from lenders/banking institutions.

FIG. 2 depicts a block diagram illustrating a host server for funding a prepaid card account with a loan.

FIG. 3 depicts a flow chart showing an example process for approving a customer's request to fund a prepaid card account with a loan.

FIG. 4 depicts a flow chart showing an example process for funding the prepaid card account.

FIG. 5 depicts a flow chart showing an example process for automatically paying the loan on or after the due date.

FIG. 6 depicts a flow chart showing an example process for managing the loan and receiving a commission.

FIG. 7 depicts a flow chart showing an example process for collecting loan payments on a periodic basis.

FIG. 8 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for finding a prepaid card account with a loan.

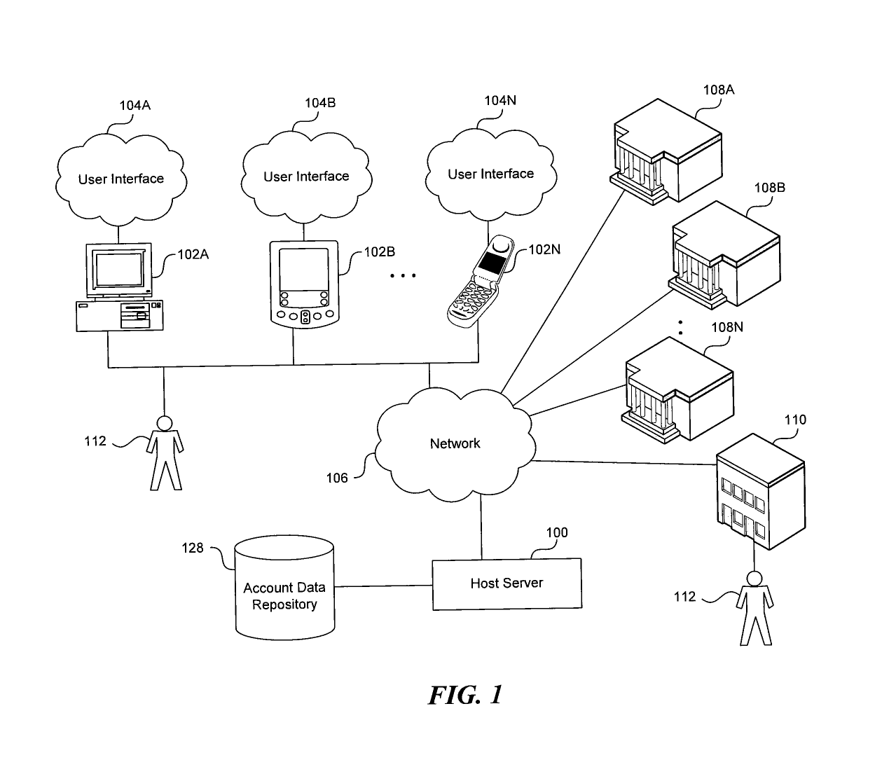

FIG. 1 illustrates a block diagram of client devices 102A-N and a host server 100 capable of funding a prepaid card account for a customer with a loan from lenders/banking institutions 108A-N.

The client devices 102A-N can be any system and/or device, and/or any combination of devices/systems that is able to establish a connection with another device, a server and/or other systems. The client devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 102A-N are coupled to a network 106. In some embodiments, the client devices may be connected to one another.

The network 106, over which the client devices 102A-N couples may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 106 broadly includes anything from a minimalist coupling of the components illustrated in the example of FIG. 1, to every component of the Internet and networks coupled to the Internet.

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2 G, 2.5 G, 3 G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client devices 102A-N can be coupled to the network (e.g., Internet) via a dial up connection, a digital subscriber loop (DSL, ADSL), cable modem, and/or other types of connection. Thus, the client devices 102A-N can communicate with remote servers (e.g., web server, host server, mail server, and instant messaging server) that provide access to user interfaces of the World Wide Web via a web browser, for example.

The account data repository 128 store software, descriptive data, images, system information, drivers, and/or any other data item utilized by parts of the host server 100 for operation. The repository 128 may also store user information, account information, loan information, including but not limited to, user profile information, financial information, bank account information, prepaid card account information, information about financial institutions, loan term, loan amount, interest rates, etc. The repository 128 may be managed by a database management system (DBMS), for example but not limited to, Oracle, DB2, Microsoft Access, Microsoft SQL Server, PostgreSQL, MySQL, FileMaker, MongoDB, CouchDB, Tokyo Cabinet, etc.

The repository 128 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

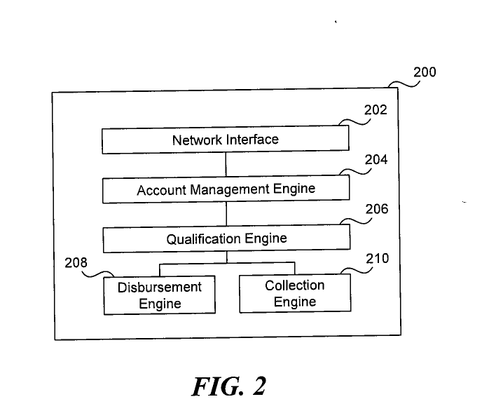

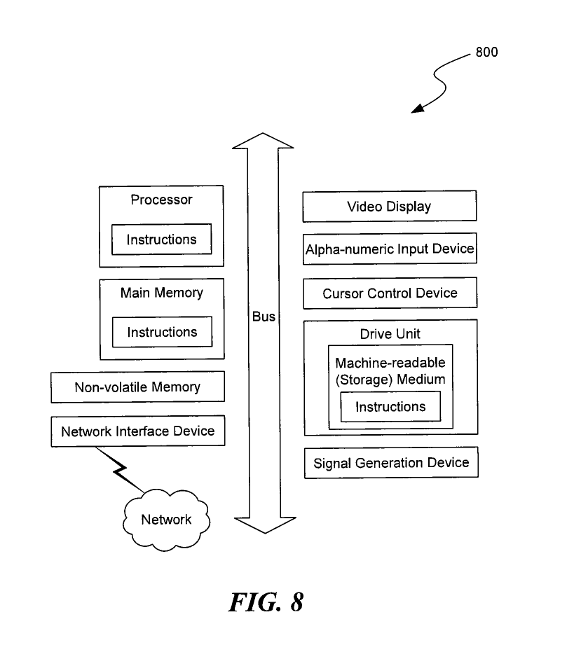

The host server 100 is, in some embodiments, able to communicate with client devices 102A-N and the lenders/banking institutions 108A-N over the network 106. In addition, the host server 100 is able to retrieve data from and/or store data in the repository 128. The host server 100 can be implemented on a known or convenient computer system, such as is illustrated in FIG. 8. The host server 100 is described in more detail with reference to FIG. 2.

The lenders/banking institutions 108A-N operate computer systems that are coupled to the network 106, which can communicate with the host server 100 and/or the client devices 102A-N. Users of client devices 102 can request that an account be opened or that an account (e.g., a prepaid card account) be funded over the network 106. The customer 112 can place the request directly through to the site hosted by the host server 100 who manages the accounts or place the request indirectly through a merchant (e.g., a commercial establishment 110).

Indirect requests can be made while the customer is initiating a transaction for goods or services at the commercial establishment 110, for example. The request can be placed by the customer 112 through an online channel (e.g., the website of the merchant) or at a physical store of the commercial establishment 110. In either instance, the establishment 110 can communicate with the host server 100 and indicate that a prepaid card account is to be created for the customer 112 and funded (e.g., through a loan) and/or that an existing prepaid card account is requested to be funded (e.g., through a loan).

The host server 100, upon receiving a request to fund a prepaid card account with a loan, can communicate with the lenders/banking institutions 108A-N. The customer's 112 credentials (e.g., financial credibility and history) used to determine qualifications for the loan can be obtained directly from the customer 112 and/or through third party credit reporting sources (not illustrated). The host server can act as a facilitator/broker of the loan and applies predetermined criteria to select which lender to send the loan to.

This criterion can include by way of example but not limitation, where the lender is licensed, whether the person has loans outstanding with the lender. In one embodiment, one set of criteria and customer qualifications are reviewed by the host server 100. If the applicant qualifies, then the application is passed through the lenders system for a decision, then the answer is passed back to the host server 100 for completion of the loan process.

The host server 100 can coordinate the loan approval process between the customer 112 and the lenders 108A-N. Once the loan is approved, the lender 108 funds the host server's 100 bank account, which subsequently funds the customer's prepaid card account with the loan funded by the lender.

In some instances, the host server 100 also facilitates payments made by the customer 112 to the lender 108 for loan repayment. For example, the customer 112 can deposit funds (e.g., the customer's own non-borrowed funds) into the prepaid card account (e.g., via direct deposit, ACH, etc.) and loan repayment can be made from the prepaid card account when it has been funded by the customer's 112 non-borrowed funds. For example, the host server 100 deducts some or all of the customer's 112 non-borrowed funds and transfers the payment(s) to the lender/banking institution 108. Services and functions associated with the host server 100 are described with further reference to the example of FIG. 2.

FIG. 2 depicts a block diagram illustrating a host server 200 for funding a prepaid card account with a loan.

In the example of FIG. 2, the host server 200 includes a network interface 202, an account management engine 204, a qualification engine 206, a disbursement engine 208, and/or a collection engine 210.

In the example of FIG. 2, the network interface 202 can be one or more networking devices that enable the host server 200 to mediate data in a network with an entity that is external to the host server, through any known and/or convenient communications protocol supported by the host and the external entity. The network interface 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

One embodiment of the host server 200 includes an account management engine 204. The account management engine 204 can be implemented, example, as software embodied in a computer-readable medium or computer-readable storage medium on a machine, in firmware, in hardware, in a combination thereof, or in any applicable known or convenient device or system.

This and other engines described in this specification are intended to include any machine, manufacture, or composition of matter capable of carrying out at least some of the functionality described implicitly, explicitly, or inherently in this specification, and/or carrying out equivalent functionality.

The account management engine 204 can be any combination of hardware components and/or software agents able to receive, process, manage, execute, a request to establish an account and/or to fund an account.

The account can generally be any type of bank account or card account (e.g., debit, credit, ATM, prepaid account, etc.) and the request may be sent directly from a customer or through a commercial establishment (e.g., while initiating a commercial transaction), either in an online environment or at a physical location. For example, the user can generate a request using a user device (e.g., a computer or handheld device) to access a website hosted by the account manager to directly send a request. The user can also use the user device to access a third party site hosted by a commercial establishment to generate the request.

In one embodiment, the account management engine 204 receives a request (e.g., either directly from a customer/consumer or from the customer/consumer through a third-party commercial establishment) to fund a prepaid card account through funds that are borrowed (e.g., through a loan from a lender such as a financial institution). The account management engine 204 can establish a communication session with a lender such as a banking institution (e.g., over a network) to facilitate the loan application process for the customer, for example.

One embodiment of the host server 200 includes a qualification engine 206. The qualification engine 206 can be implemented, for example, as software embodied in a computer-readable medium or computer-readable storage medium on a machine, in firmware, in hardware, in a combination thereof, or in any applicable known or convenient device or system. The qualification engine 206 can be any combination of hardware components and/or software agents able to determine whether the customer qualifies for funding a prepaid card account through a loan.

The qualification engine 206, for example, compares user data of the customer to a set of metrics to determine whether the customer meets the criteria. For example, the user data can include, by way of example, a credit history report, address verification, social security number verification, address verification, and/or employment verification, etc. The criteria can be set by the account manager and/or by the third party lender. For example, the qualification engine 206 can verify customer identity and the status of the customer as a direct deposit customer. Then the applicant and application data can be sent through to the lender for final approval.

For example, the customer may not be eligible due to the state that they reside in (e.g., the lender may not be licensed in certain states). In addition, the customer may be ineligible because they have had insufficient recurring direct deposits with the account manager (e.g., who operates the host server 200). The direct deposits can be from any third party such as an employer. In some instances, a customer who is otherwise ineligible can set up direct deposit to become eligible for funding a prepaid card account with a loan. In some instances, the amount of the loan may be restricted depending on the number of direct deposits that have been received by the host server 200.

If the customer meets the criteria, the loan amount and terms can then be determined and set by the lender. In some instances, the qualification engine 206 validates the address of the customer on file and submits a loan application form to the lender. This can be implemented through an API with the lender where we send customer information to the lender, they will provide a response back with a decision and the amount the borrower is approved for.

Using this information (e.g., the user data of the customer, loan application information, financial/credit history, requested loan amount, income level, etc.), the lender can determine the loan amount and loan terms.

The host server 200 or the lender can then display the loan amount, payment terms, and other loan terms to the customer/consumer which can be either be accepted by or declined by the customer. Once accepted, the lender can then fund a bank account of the account manager (host server 200). The host server 200 can then fund the customer's prepaid card account with the loan, for example, via the disbursement engine 208.

One embodiment of the host server 200 includes a disbursement engine 208. The disbursement engine 208 can be implemented, for example, as software embodied in a computer-readable medium or computer-readable storage medium on a machine, in firmware, in hardware, in a combination thereof, or in any applicable known or convenient device or system. The disbursement engine 208 can be any combination of hardware components and/or software agents able to supply a customer's account with funds.

Specifically, the disbursement engine 208 in the host server 208 is able to fund a customer's prepaid card account with a loan obtained from a lender. When the customer accepts the loan terms presented by the lender, the lender then funds the account manager's (e.g., host server 200) bank account from the lender's bank account. In one embodiment, the lender's bank account and the account manager's bank account are opened with the same banking institution such that funds can be available on the same day the wire is initiated. The funds disbursement engine 208 then, using the funds in the account manager's bank account, funds the prepaid card account. The customer can then use the prepaid card account funded with the loan for commercial transactions in an online or physical setting.

One embodiment of the host server 200 includes a collection engine 210, which may be coupled to the account management engine 210. The collection engine 210 can be implemented, for example, as software embodied in a computer-readable medium or computer-readable storage medium on a machine, in firmware, in hardware, in a combination thereof, or in any applicable known or convenient device or system. The collection engine 210 can be any combination of hardware components and/or software agents able to facilitate repayment of the loan by the customer.

In one embodiment, the collection engine 210 determines whether the prepaid card account has been supplied with non-borrowed funds (e.g., the customer's own funds deposited, for example, by him/herself or by a third party such as an employer). If so, the collection engine 210 deducts from the non-borrowed funds that transfers the funds to the lender as repayment of the loan. The collection engine 210 can deduct, from an amount that is equal to the loan amount plus interest and returns the amount to the lender, if the non-borrowed funds is sufficient.

If insufficient, the collection engine 210 can deduct some lesser amount from the non-borrowed funds so as to not create a negative balance on the prepaid card account. The collection engine 210 can return the deducted amount to the lender and record the new balance on the loan. In one embodiment, the collection engine 210 checks the prepaid account on a periodic basis (e.g., daily, weekly, bi-weekly, monthly, etc.) to determine whether additional non-borrowed funds have been deposited and deducts amounts until the loan amount plus interest have been paid back to the lender.

The amount that is deducted may be set by the lender and may be subsequently modified by the lender, for example if they allow rollover of the loan amount. In which case, they lender notifies the host server 200 of the new loan amount and the collection date for the payment. In some cases, the repayment date will either be the date the lender requested or the next deposit date but not less than a predetermined amount of time. For example, repayment may be scheduled for the next deposit date but not less than 10 days from the loan date.

The collection engine 210 can record the new balances as a result of the deductions and reports the new balances on the loan and/or the prepaid card account to the lender.

The components of the host server 200 are a functional unit that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 200 without deviating from the spirit of the disclosure.

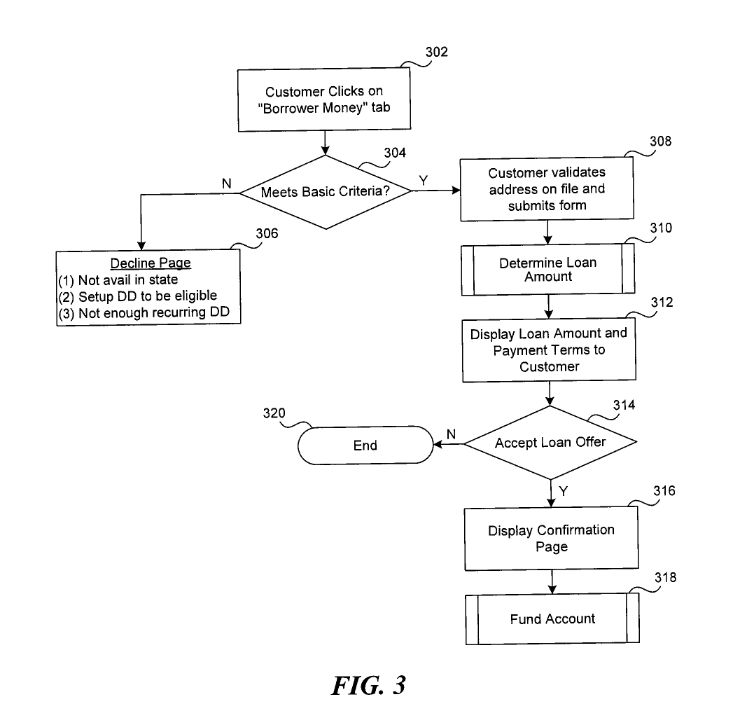

FIG. 3 depicts a flow chart showing an example process for approving a customer's request to fund a prepaid card account with a loan.

In process 302, a customer/consumer generates a request to fund a prepaid card account with borrowed funds (e.g., through a loan from a bank or other third parties). The request may be generated on a user device through an online environment. For example, the customer can click on a tab on the account manager's site (e.g., the site hosted by the host server 100 or 200 in FIG. 1 and FIG. 2 respectively) to initiate a request (e.g., “Borrow money” tab). Other means of making the request including placing a phone call, visiting the physical location, is also possible.

In process 304, it is determined whether the requesting customer/consumer meets the basis criteria. Basic Criteria would be if the customer is on direct deposit, and how many direct deposits they have, and the type of deposits made, e.g., not tax deposits. If not, in process 306 the customer is presented with a web page declining the customer the request. The customer may be declined if he/she resides in a state where services are not available or does not have direct deposit setup. The customer may also be declined if he/she has not had enough recurring direct deposits with the account manager. In some instances, the recurring deposits can determine the eligible loan amount. For example, an applicant may need two direct deposits to qualify for any loan, and will be eligible for higher loan amounts as more direct deposits are received. In some instances, the customer may be offered an opportunity to set up direct deposit or to adjust their direct deposit settings to become eligible.

If the customer meets the basic criteria, in process 308, the customer validates the address that is on file and submits the form. For example, the customer information can be passed by API to the lender who would respond with a decision and subsequently provide any documentation to the lender that is required. The lender then uses the verified customer information, user data, and loan application information to determine the loan amount and terms of the loan including but not limited to, one or more of, due date, the loan amount, payment terms, and interest amount. The loan terms are then displayed to the customer (e.g., via the client device) in process 312.

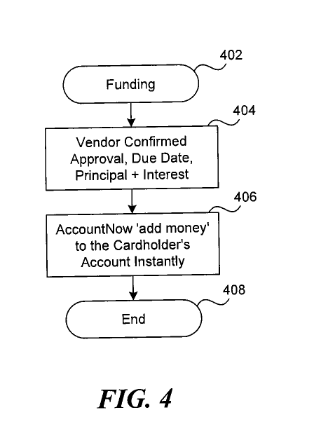

If the customer does not accept the loan terms, then in process 320, the process ends. If the customer accepts the loan terms in process 314, a confirmation page can be displayed in process 316. The prepaid card account can then be funded in step 318. The funding process is illustrated with further reference in the example of FIG. 4.

FIG. 4 depicts a flow chart showing an example process for funding the prepaid card account.

In process 402, the lender or vendor funds a bank account of the account manager. In some instances, the account manager's bank account is with the same banking institution as the lender's bank account. In process 404, the vendor (e.g., lender or other third party) confirms, with the account manager, the loan approval and the terms of the loan (e.g., due date, loan amount, interest, etc.). In process 406, the account manager funds the prepaid card account of the customer. This can be performed immediately upon confirmation of the terms of the loan and receipt of funds in the account manager's bank account.

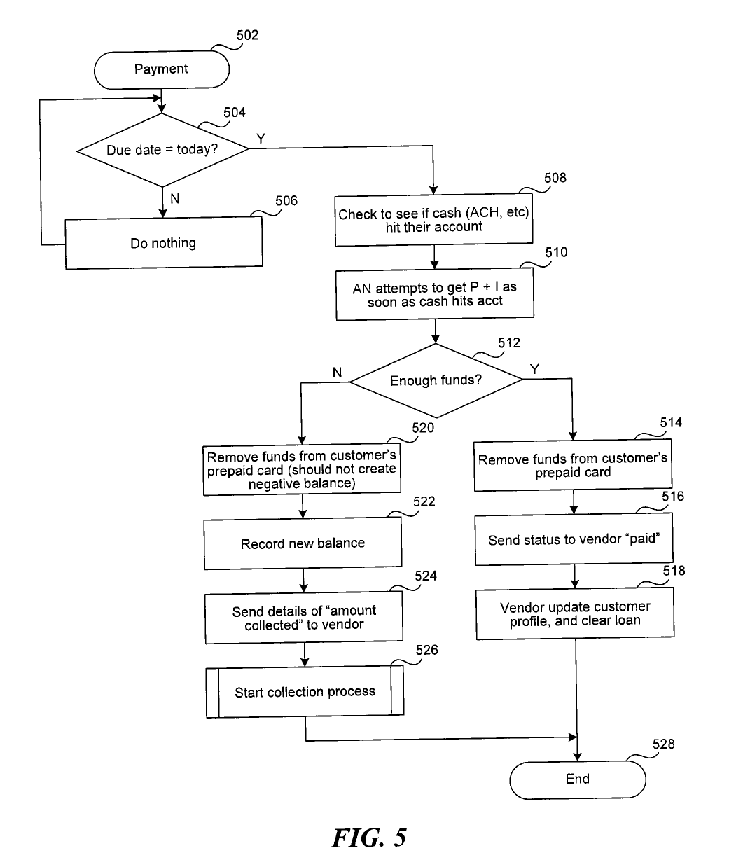

FIG. 5 depicts a flow chart showing an example process for automatically making payments on the loan on or after the due date.

The account manager can automatically manage the payment process 502. For example, in process 504, it is determined if the due date on the loan has been reached or exceeded. If not, the payment process is not performed.

If so, in process 508, the account manager checks to determine whether the cash (e.g., non-borrowed funds) has been deposited into the account (e.g., the prepaid card account), for example, via direct deposit, ATM, ACH, etc. If so, in process 510, the account manager attempts to deduct funds from the account sufficient to cover the loan amount plus the interest. In process 512, the account manager determines whether there are sufficient funds. If so, in process 514, the funds are removed from the customer's prepaid card account and sent to the lender or other third party vendor in process 516. In process 518, the account manager can send the “paid status” to the lender or vendor and the vendor may update the customer's profile and clear the loan, in process 518.

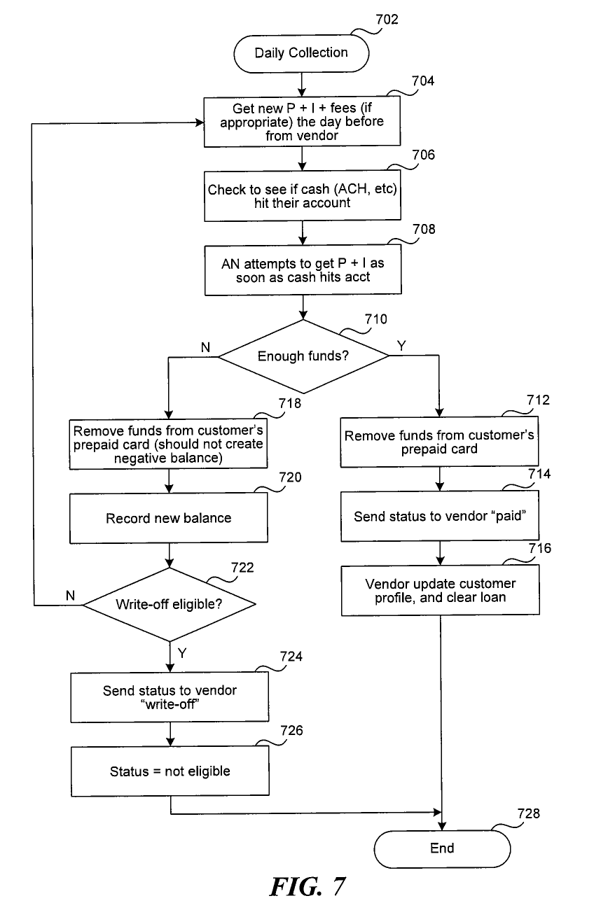

If the prepaid account does not have sufficient funds for repayment of the loan and interest in full, the account manager deducts the funds from the customer's prepaid card in process 520 so as to not create a negative balance and records the new balance in process 522. In process 524, the details of the amount collected and the new balance are sent to the lender/vendor and the account manager begin the collection process 528, which is illustrated with further reference to the example of FIG. 7.

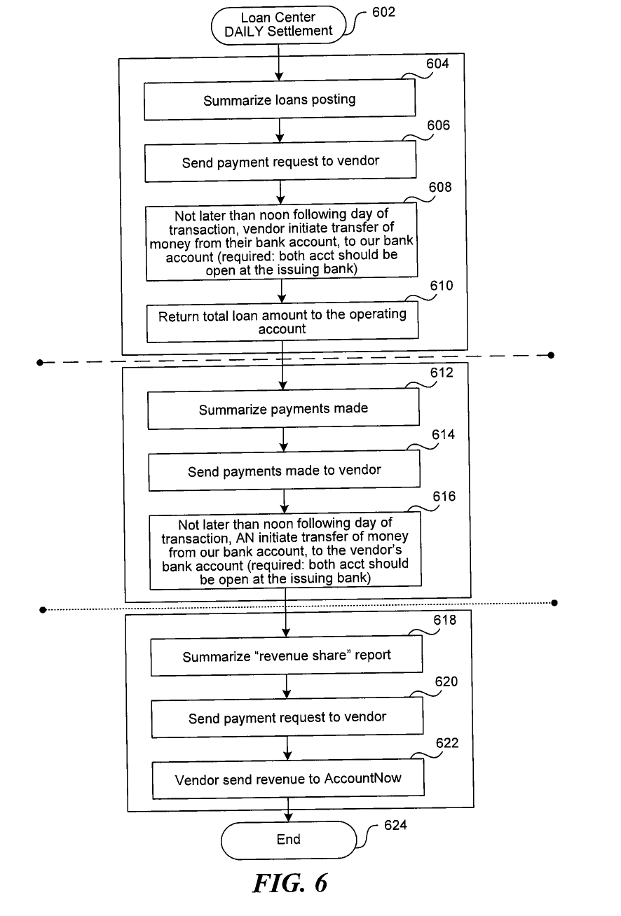

FIG. 6 depicts a flow chart showing an example process for managing the loan and receiving a commission.

In process 604, the loan manager summarizes the posting of the loan. In process 606, the account manager sends the payment request (e.g., for the funding of the loan) to the lender or other third party vendor. In process 608, the lender initiates the transfer of the funds to the account manager's bank account. Generally, the account manager's bank account is opened at the same bank where the funds are coming from. In process 610, the account manager transfers the funds in the full loan amount to the prepaid card account (“operating account”).

The account manager also summarizes the payments made by the customer in process 612 and sends the payments to the vendor, in process 614. In process 616, the account manager initiates transfer of the payments to the lender/vendor's bank account. Typically, the account manager initiates the transfer no later than noon following the day of the payment transaction.

In process 618, the account manager generates a report showing the revenue made and how the revenue is to be shared with the lender. The revenue report can include, by way of example but not limitation, an amount of loans processed, fees assessed, fees collected, net fees earned by the account manager, for example. In process 620, a request for payment is sent to the lender/vendor. In process 622, the lender/vendor sends payment to the account manager (e.g., a commission) for initiating the client.

FIG. 7 depicts a flow chart showing an example process for collecting loan payments on a periodic basis.

In process 702, the account manager performs the collection process for loan repayment. In process 704, the account manager can communicate with the lender/vendor periodically to determine the new balance that is due (e.g., the principal, interest, and any additional fees). In process 706, the account manager can determine whether cash (non-borrowed funds) have been deposited into the customer's prepaid card account.

In process 708, the account manager attempts to deduct the loan amount plus interest from the prepaid account and determines whether there are sufficient funds in process 710. If so, in process 712, the account manager deducts the funds from the customer's prepaid account and notifies the lender/vendor of the paid status in process 714. In process 716, the lender/vendor and update the customer's profile and loan status as being cleared.

If not, in process 718, some funds are deducted from the prepaid card account so as to not create a negative balance and records the new balance in process 720. In process 722, it is determined whether the prepaid account is eligible for write-off. For example, if a loan is not paid back after a predetermined period, its status will become a loss, and may be written off by the lender. If a loan is written off, the lender can continue to make collections efforts to recover the funds but the customer would not be able to borrow again.

If so, the lender/vendor is notified of the write-off status in process 724 and the status is updated to being not eligible for future write offs in process 726.

FIG. 8 shows a diagrammatic representation of a machine in the example form of a computer system 800 within which a set of instructions, for causing the machine to perform any one or more of the methodologies discussed herein, may be executed.

In the example of FIG. 8, the computer system 800 includes a processor, memory, non-volatile memory, and an interface device. Various common components (e.g., cache memory) are omitted for illustrative simplicity. The computer system 800 is intended to illustrate a hardware device on which any of the components depicted in the example of FIG. 1 (and any other components described in this specification) can be implemented. The computer system 800 can be of any applicable known or convenient type. The components of the computer system 800 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 800. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1100. The interface can include an analog modem, isdn modem, cable modem, token ring interface, satellite transmission interface (e.g. “direct PC”), or other interfaces for coupling a computer system to other computer systems. The interface 208 can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 8 reside in the interface.

In operation, the computer system 800 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of supplying funds to a prepaid card account, comprising:
receiving, by an account manager at a host server, a request from a customer to fund the prepaid card account through obtaining a loan from a lender;
wherein, the customer generates the request via a client device;
comparing user data of the customer to a set of metrics to determine whether the customer meets qualifications for funding the prepaid card account through the loan;
in response to determining that the customer meets the qualifications, determining terms of the loan including a loan amount and payment terms;
presenting the terms of the loan to the user via the user device;
responsive to the customer accepting the terms of the loan, funding, by the account manager, the prepaid card account using the loan.

2. The method of claim 1, wherein, the lender credits the account manager a commission, based on a contract with the lender.

3. The method of claim 1,
further comprising, generating, by the account manager at the host server, a revenue share report;
wherein, the lender credits the commission in response to the account manager sending the lender a payment request.

4. The method of claim 1, wherein, prior to the account manager funding the prepaid card account, the lender funds a second bank account of the account manager from a first bank account of the lender.

5. The method of claim 2, wherein, the first bank account and the second bank account are opened with a bank that is funding the loan.

6. The method of claim 1, further comprising, receiving from the lender, by the host server, the terms of the loan including, one or more of due date, the loan amount, payment terms, and interest amount.

7. The method of claim 6, further comprising,
on or after the due date, determining whether the prepaid card account has been supplied with non-borrowed funds;
determining whether the non-borrowed funds is sufficient for returning the loan amount and interest amount.

8. The method of claim 7, wherein,
if the non-borrowed funds is sufficient, deducting the loan amount and interest amount from the prepaid card account;
notifying the lender that the customer has satisfied the terms of the loan.

9. The method of claim 8, further comprising: transferring the collected loan amount plus interest from the second bank account of the account manager to the first bank account of the lender.

10. The method of claim 7, further comprising:
if the non-borrowed funds is insufficient, deducting funds from the prepaid card account;
computing a new balance on the loan;
notifying the lender of the new balance or the amount of the deducted funds.

11. The method of claim 10, further comprising,
periodically checking the prepaid card account to determine whether additional non-borrowed funds have been deposited and deducting additional funds until the loan amount and interest amount have been deducted;
recording the new balances as a result of the deduction;
reporting the new balances to the lender;
wherein, the deductions do not create negative balance in the prepaid card account.

12. The method of claim 11, wherein, the prepaid card account is checked daily for deposits of the additional non-borrowed funds.

13. The method of claim 10, further comprising: determining whether the prepaid card account is eligible for write-off.

14. The method of claim 13, further comprising: if the prepaid card account is eligible for write-off, sending the write-off status to the lender.

15. A system for supplying funds to a prepaid card account, comprising:
an account management engine that receives, a request from a customer to fund the prepaid card account through obtaining a loan from a lender;
wherein, the account management engine communicates with the lender over a network;
wherein, the customer generates the request via a user device;
a qualification engine coupled to the account management engine;
wherein, the qualification engine compares user data of the customer to a set of metrics to determine whether the customer meets qualifications for funding the prepaid card account through the loan
in response to determining that the customer meets the qualifications,
the lender determines terms of the loan including a loan amount and payment terms;
responsive to the customer accepting the terms of the loan, the lender funds, a first bank account of the account manager, through a banking institution, the first bank account being funded in the amount of the loan from a second bank account of the lender;
a funds disbursement engine coupled to the account management engine;
wherein, the funds disbursement engine funds the prepaid card account for the customer using the loan.

16. The system of claim 15,
further comprising, a collection engine coupled to the account management engine;
wherein, the collection engine determines whether the prepaid card account has been supplied with non-borrowed funds and deducts the non-borrowed funds and transfers the non-borrowed funds back to the lender as a repayment of the loan.

17. The system of claim 16, wherein, the collection engine deducts, from the non-borrowed funds, if sufficient, an amount equal to the loan amount plus interest and returns the amount to the lender.

18. The system of claim 17,
wherein, if insufficient, the collection engine deducts some amount from the non-borrowed funds so as to not create a negative balance on the prepaid card account and returns the deducted amount to the lender and records a new balance on the loan;
wherein, collection engine checks the prepaid account on a periodic basis to determine whether additional non-borrowed funds have been deposited and deducts amounts until the loan amount plus interest have been paid back to the lender.

19. The system of claim 15, wherein, the first and second bank accounts are both opened through the banking institution.

20. The system of claim 15, wherein, the customer uses the prepaid card account funded with the loan for commercial transactions in an online or physical setting.

21. The system of claim 15, wherein, the request is generated via the user device through a hosted website of the account manager or through a third party site.
